(19) United States
(12) Patent Application Publication
(10) Pub. No.: US 2026/0231031 A1
(43) Pub. Date: Aug. 6, 2026

(54) USER EQUIPMENT AND METHODS OF LP-WUR POWER SAVING ENHANCEMENT

(71) Applicant: SHENZHEN TCL NEW TECHNOLOGY CO., LTD., Shenzhen, Guangdong (CN)

(72) Inventor: Shahid JAN, Shenzhen, Guangdong (CN)

(73) Assignee: SHENZHEN TCL NEW TECHNOLOGY CO., LTD., Shenzhen, Guangdong (CN)

(21) Appl. No.: 19/149,528

(22) PCT Filed: Feb. 17, 2023
(86) PCT No.: PCT/CN2023/076871

§ 371 Date: Jul. 18, 2025

(51) Int. Cl. H04W 52/02

(52) U.S. Cl. CPC H04W 52/0235

(57) ABSTRACT

Various methods relate to the enhancement of LP-WUR power saving. A first method enhances the LP-WUR power saving via the LP-WUR monitoring procedure for low power wake up signal (LP-WUS) detection includes enabling a continuous monitoring behavior of LP-WUR for LP-WUS detection for a time duration when a UE is triggered by a network to wake up and disabling the continuous monitoring behavior of LP-WUR for LP-WUS detection until the UE is again trigger by the network to wake up. A second method enhances the LP-WUR power saving via a bandwidth configuration for LP-WUS to the UE in terms of PRBs at the lower edge or at upper edge PRBs of a carrier bandwidth, or a configuration of a dedicated bandwidth part (BWP) to the UE for LP-WUS transmission along with the LP-SS. A third method enhances the LP-WUR power saving enhancement via LP-WUR based RRM relaxation.

### BACKGROUND OF DISCLOSURE

### 1. Field of the Disclosure

The present disclosure relates to the field of wireless communication systems, and more particularly, to a user equipment (UE) and a method of low power wake up receiver (LP-WUR) monitoring procedure for low power wake up signal (LP-WUS) detection in 5G new radio (NR) communication system. More specifically, the present disclosure discusses several methods to reduce the power consumption of low power wakeup receiver (LP-WUR).

### 2. Description of the Related Art

Energy efficiency is one of the basic requirements of 5G system due its support of diverse use cases including power sensitive devices such as IoT (industrial wireless sensors, controllers), wearables etc. The power consumption of these devices depends on the configured length of wake-up periods, e.g., paging cycle. To meet the battery life requirements, eDRX cycle with large value is expected to be used, resulting in high latency, which is not suitable for such services with requirements of both long battery life and low latency. For instance, in fire detection and extinguishment use case, fire shutters shall be closed, and fire sprinklers shall be turned on by the actuators within 1 to 2 seconds from the time the fire is detected by sensors, thus long eDRX cycle cannot meet the delay requirements, eDRX is apparently not suitable for latency-critical use cases. In DRx and eDRx cycle, the UEs need to periodically wake up once per DRX cycle, which dominates the power consumption in periods with no signaling or data traffic. If UEs are able to wake up only when they are triggered, e.g., paging in idle/inactive state and PDCCH in connected state, power consumption could be dramatically reduced. This can be achieved by using a wake up signal to trigger the main radio (MR) and a separate receiver which has the ability to monitor the wake up signal with ultra-low power consumption as mentioned by the following objectives of the study item description (SID): Primarily target low-power WUS/WUR for power-sensitive, small form-factor devices including IoT use cases (such as industrial sensors, controllers) and wearables. Study and evaluate wake-up signal designs to support wake-up receivers [RAN1, RAN4]. Study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead should be included in the study [RAN1]. In addition, the low power wake up signal (LP-WUS) also focus on the low latency requirements e.g. lower than eDRX latency to support diverse use cases.

In prior art, several companies have proposal about the LP-WUR monitoring behavior for LP-WUS detection. However, there is no concrete proposal which targets the LP-WUR monitoring behavior to increase the LP-WUR power saving. Furthermore, in prior art there are no clear proposal of bandwidth configuration for LP-WUS, and the LP-WUR based RRM measurement relaxation which can enhance the LP-WUR power saving. Therefore, there is a need to further study the LP-WUR monitoring behavior for LP-WUS detection/decoding to avoid the unnecessary decoding of each LP-WUS, reduce the LP-WUR power consumption.

### SUMMARY

An object of the present disclosure is to propose a user equipment (UE) and a method of low power wake up receiver (LP-WUR) monitoring procedure for low power wake up signal (LP-WUS) detection, to study the LP-WUR monitoring behavior for LP-WUS detection/decoding to avoid the unnecessary decoding of each LP-WUS, reduce the LP-WUR power consumption.

In a first aspect of the present disclosure, a method of low power wake up receiver (LP-WUR) monitoring procedure for low power wake up signal (LP-WUS) detection includes enabling and disabling, by a user equipment (UE), an LP-WUR monitoring behavior based on a payload of a low power synchronization signal (LP-SS) and/or an on/off status of a main radio (MR) of a UE. In an example, enabling a continuous monitoring behavior of LP-WUR for LP-WUS detection for a time duration when a user equipment (UE) is triggered by a network to wake up and disabling the continuous monitoring behavior of LP-WUR for LP-WUS detection for a time duration from a first trigger until the UE is again trigger by the network to wake up.

In a second aspect of the present disclosure, a user equipment (UE) is configured to enable a continuous monitoring behavior of low power wake up receiver (LP-WUR) for low power wake up signal (LP-WUS) detection for a time duration when the UE is triggered by a network to wake up, and the UE is configured to disable the continuous monitoring behavior of LP-WUR for LP-WUS detection for a time duration from a first trigger until the UE is again trigger by the network to wake up.

In a third aspect of the present disclosure, a user equipment (UE) is configured with a frequency location for the LP-WUS receiving at the lower edge physical resources blocks (PRBs) or the upper edge physical resource blocks (PRBs) of a carrier bandwidth.

In a fourth aspect of the present disclosure, a user equipment (UE) is configured with a dedicated downlink bandwidth part (BWP) for LP-WUS and/or LP-SS with a maximum bandwidth not greater than a required bandwidth of the LP-WUS.

In a fifth aspect of the present disclosure, when a UE enters into the LP-WUS mode, some radio resource management (RRM) measurement, performed by the LP-WUR of the UE, wherein the LP-WUR based RRM measurement comprises an RRM measurement only, an RRM relaxation based on the group of UEs, and/or an RRM measurement based on the LP-WUS.

In a third aspect of the present disclosure, a user equipment comprises a memory, a transceiver, and a processor coupled to the memory and the transceiver. The processor is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eight aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic diagram illustrating an example of LP-WUR in IEEE.

FIG. 1B is a schematic diagram illustrating another example of LP-WUR in IEEE.

FIG. 2 is a schematic diagram illustrating an example of unnecessary decoding of the LP-WUS.

FIG. 3 is a schematic diagram illustrating an example of unnecessary power consumption due to continue monitoring of the LP-WUR for LP-WUS detection.

FIG. 4 is a block diagram of one or more user equipment's and a network/gNB of communication in a communication network system according to an embodiment of the present disclosure.

FIG. 5 is a flowchart illustrating a method of low power wake up receiver (LP-WUR) monitoring procedure for low power wake up signal (LP-WUS) detection according to an embodiment of the present disclosure.

FIG. 6 is a schematic diagram illustrating an example of LP-SS with payload to perform enabling/disabling of LP-WUR/WUS monitoring according to an embodiment of the present disclosure.

FIG. 7 is a schematic diagram illustrating an example of LP-WUR Avoids unnecessary detection for LP-WUS decoding according to an embodiment of the present disclosure.

FIG. 8 is a schematic diagram illustrating an example of enabling/disabling of LP-WUR monitoring based on the MR on/off status according to an embodiment of the present disclosure.

FIG. 9 is a schematic diagram illustrating an example of implicit indication of UE for LP-WUS reception according to an embodiment of the present disclosure.

FIG. 10 is a schematic diagram illustrating an example of explicit indication of UE LP-WUS reception according to an embodiment of the present disclosure.

FIG. 11 is a schematic diagram illustrating an example of timer based solution for LP-WUS reliability according to an embodiment of the present disclosure.

FIG. 12 is a schematic diagram illustrating an example of LP-WUR RF retuning for LP-SS and LP-WUS according to an embodiment of the present disclosure.

FIG. 13 is a schematic diagram illustrating an example of LP-WUR searching the whole BWP to detect the LP-WUS according to an embodiment of the present disclosure.

FIG. 14 is a schematic diagram illustrating an example of bandwidth Configuration for LP-WUS according to an embodiment of the present disclosure.

FIG. 15 is a block diagram of a UE for wireless communication according to an embodiment of the present disclosure.

FIG. 16 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

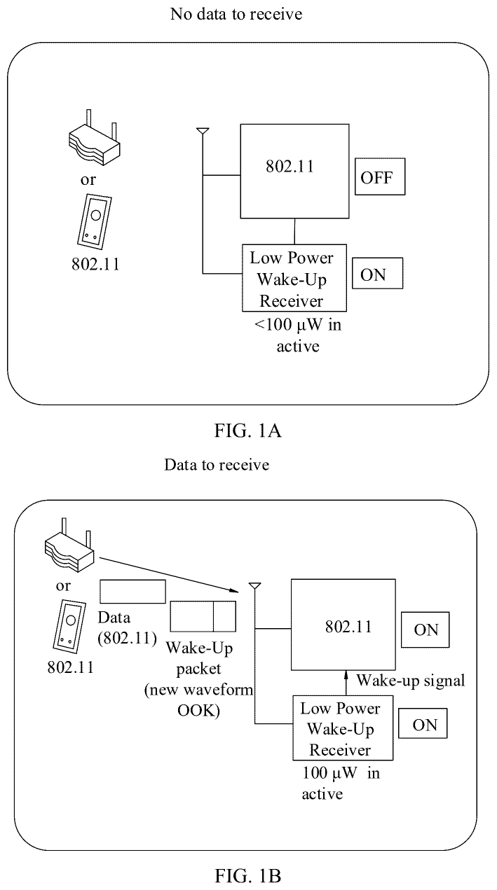

The basic procedure and working principle of LP-WUS and LP-WUR is illustrated in FIG. 1A and FIG. 1B, where the main radio is used for data transmission and reception only, which can be turned OFF or set to deep sleep unless it is turned on, while the low power wake up receiver (LP-WUR) stays ON to monitor the wake up signals. The illustration diagram of LP-WUS and LP-WUR is based on the IEEE low power receiver architecture, and it can be considered as a baseline to design the LP-WUS procedure and LP-WUR architecture for 3GPP cellular network.

The key requirements of Rel-18 low power WUS/WUR is to allow the main radio (MR) of a UE to sleep for long time and trigger the MR only when the UE has to receive or transmit the data or signaling, in order to enhance the UE power saving without trade-off for latency. However, the power consumption of LP-WUR is greatly impacted by the monitoring behavior of LP-WUR for LP-WUS detection, the bandwidth of LP-WUS, and the RRM measurement performed by LP-WUR. For instance, in case the LP-WUR of a UE continuously monitor the LP-WUS, it can consume more power as compared to the duty cycle based monitoring of LP-WUS, where the LP-WUR monitors the LP-WUS in a specific duration. In addition, the transmission of LP-WUS signals which can be periodic or configured in a specific occasion also impact the LP-WUR power consumption. The key issues which can increase the LP-WUR power consumption are summarized below.

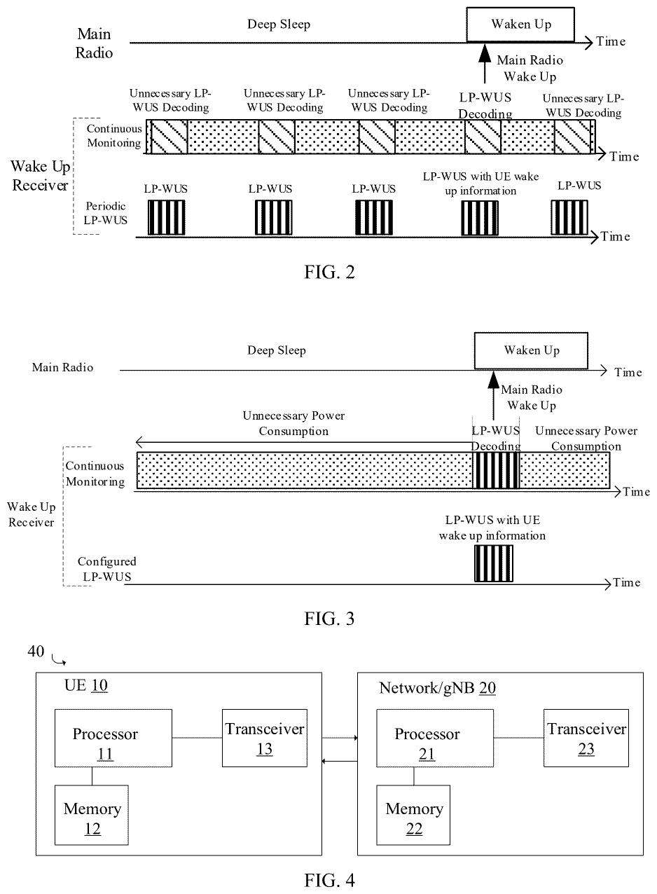

1. For continuous monitoring behavior of LP-WUR for LP-WUS detection, the LP-WUR of UE may unnecessarily decode all the periodic or configured LP-WUS which may not include the UE MR Trigger information and thus it can increase the LP-WUR power consumption as shown in FIG. 2. Similarly, the continuous monitoring of the LP-WUR can consume unnecessary power due to continuous monitoring of LP-WUR for LP-WUS detection while there is no LP-WUS transmitted by the network as shown in FIG. 3.

2. The bandwidth of LP-WUS may also affect the LP-WUR power consumption in case, when then LP-SS and LP-WUS are not configured in the same BWP and the LP-WUR has to perform frequent RF retuning to receive the LP-SS for synchronization with the network. In addition, the LP-WUR of UE will consume more power when it searches the existing whole active DL BWP for LP-WUS detection, as explained in the following embodiments in more details.

3. The RRM measurement performed by LP-WUR may also affect the power consumption of the LP-WUR as explained in detail in the following embodiments.

Therefore, it is necessary to study further the LP-WUR monitoring behavior for LP-WUS detection/decoding to avoid the unnecessary decoding of each LP-WUS, reduce the LP-WUR power consumption. In this disclosure, some embodiments further study the LP-WUR monitoring behavior for LP-WUS detection, bandwidth and BWP configuration for LP-WUS, and RRM relaxation performed by the LP-WUR in the LP-WUS mode, to enhance the LP-WUR power saving.

The main objective of this invention is to define and develop an ultra-low power mechanism and study different methods to enhance the LP-WUR power saving. The proposed solutions to achieve our objectives are summarized as below.

1. Solutions of enabling/disabling of LP-WUR monitoring behavior for LP-WUS detection are proposed to enhance the LP-WUR power saving as given below:

Enabling and disabling of the LP-WUR monitoring behavior is based on the payload carries by the LP-SS.

Enabling and disabling of the LP-WUR monitoring behavior is based on the Main Radio (MR) ON/OFF status.

2. Solutions of the LP-WUR power consumption reduction has proposed based on the required bandwidth of the LP-WUS and low complex architecture of the LP-WUR as given below:

Configuration of LP-WUS bandwidth to the UE is proposed to reduce the LP-WUR power consumption for LP-WUS detection.

Dedicated BWP for LP-WUS and LP-SS is proposed to avoid the LP-WUR RF retuning and reduce the LP-WUR power consumption for LP-WUS decoding.

3. Several RRM relaxation solutions for LP-WUR based RRM on the top of the existing RRM relaxation are proposed to reduce the power consumption of LP-WUR for RRM measurement and support mobility.

This disclosure discussed several methods of LP-WUR power consumption reduction and

have the following advantages: 1. Enhance the LP-WUR power saving. 2. Avoid the unnecessary LP-WUS decoding and reduce the complexity of LP-WUR. 3. Avoid the LP-WUR RF retuning for LP-WUR synchronization with the network. 4. Support the UEs mobility in the LP-WUS mode.

FIG. 4 illustrates that, in some embodiments, one or more user equipments (UEs) 10 and a network/gNB 20 for communication in a communication network system 40 according to an embodiment of the present disclosure are provided. The communication network system 40 includes one or more UEs 10 and a network/gNB 20. The one or more UEs 10 may include a memory 12, a transceiver 13, and a processor 11 coupled to the memory 12 and the transceiver 13. The network/gNB 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

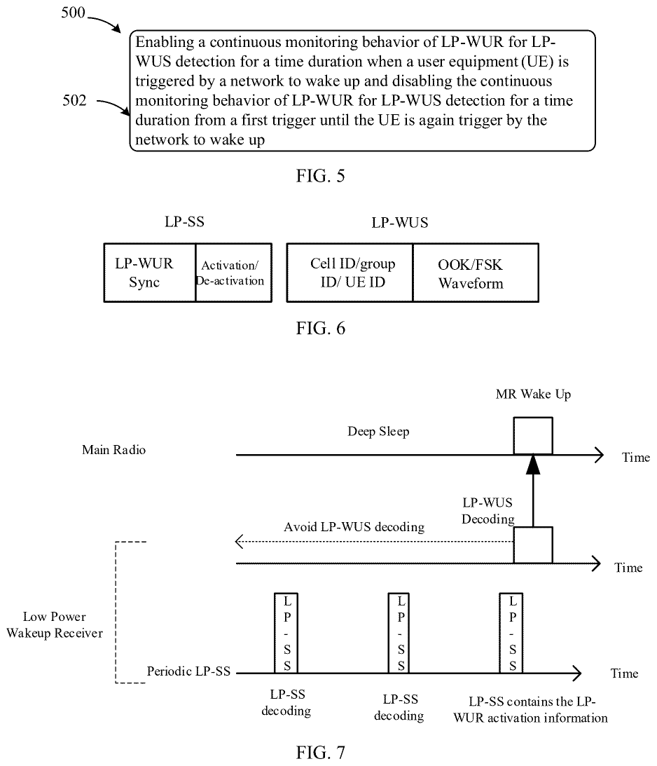

FIG. 5 illustrates a method 500 of low power wake up receiver (LP-WUR) monitoring procedure for low power wake up signal (LP-WUS) detection according to an embodiment of the present disclosure. The method 500 includes enabling and disabling, by a user equipment (UE), an LP-WUR monitoring behavior based on a payload of a low power synchronization signal (LP-SS) and/or an on/off status of a main radio (MR) of a UE. In some embodiments, the method 500 includes: a block 502, enabling a continuous monitoring behavior of LP-WUR for LP-WUS detection for a time duration when a user equipment (UE) is triggered by a network to wake up and disabling the continuous monitoring behavior of LP-WUR for LP-WUS detection for a time duration from a first trigger until the UE is again trigger by the network to wake up. Further, the processor 11 is configured to perform the above method 500. The processor 11 is also configured to perform the method in the following some embodiments. This can target the LP-WUR monitoring behavior to increase the LP-WUR power saving.

In some embodiments, enabling and disabling the continuous monitoring behavior of LP-WUR for LP-WUS detection is via a bitmap in the payload of the LP-SS. In some embodiments, each bit in the bitmap is assigned to the UE or a group of UEs according to a UE identifier (ID) or a group ID of UEs in an ascending order when the UEs enter into an LP-WUS mode. In some embodiments, a length of the payload is defined as X bits, where X is a total number of bits for enabling/disabling function and is in a range of {2, 4, 8} bits. In some embodiments, when a number of information carries in the payload is less than a total bit length of the payload, the remaining unused bits is considered as reserved bits. In some embodiments, when a bit value of the bitmap is a first value, the continuous monitoring behavior of LP-WUR for LP-WUS detection is enabled, and when the bit value is a second value, the continuous monitoring behavior of LP-WUR for LP-WUS detection is disabled. In some embodiments, enabling and disabling the continuous monitoring behavior of LP-WUR for LP-WUS detection is performed based on the UEs or UE groups. In some embodiments, the LP-SS is a periodic LP-SS.

In some embodiments, when the MR of the UE is on, the continuous monitoring behavior of LP-WUR of the UE for LP-WUS detection is considered to be de-activated until the MR of the UE is on. In some embodiments, when the MR of the UE is off, the continuous monitoring behavior of LP-WUR of the UE for LP-WUS detection is considered to be activated. In some embodiments, enabling and disabling the continuous monitoring behavior of LP-WUR for LP-WUS detection comprises transmitting, by an MR of a UE, an indication to the network that the LP-WUS has successfully received and decoded by the LP-WUR of the UE. In some embodiments, the indication is used for the network to derive from a first ACK message from the MR of the UE after receiving data/signaling. In some embodiments, the indication is used when the LP-WUS triggers the MR to wake up, the MR sends an ACK message to the network and let the network knows that the LP-WUS has successfully received. In some embodiments, when the UE is unable to detect/decode the LP-WUS and the network does not receive any ACK message from the MR of the UE until a timer is expired, the LP-WUS is re-transmit for the UE or the group of UEs. In some embodiments, a duty cycle of the continuous monitoring behavior of LP-WUR for LP-WUS detection is derived from a DRX configuration and/or eDRx configuration. Further, the above embodiments can enhance the LP-WUR power saving, avoid the unnecessary LP-WUS decoding and reduce the complexity of LP-WUR, avoid the LP-WUR RF retuning for LP-WUR synchronization with the network, and/or support the UEs mobility in the LP-WUS mode.

In some embodiments, a method of a bandwidth configuration for low power wake up signal (LP-WUS) to the UE includes a bandwidth configuration for LP-WUS with a defined frequency location. In some embodiments, the configured bandwidth in terms of physical resource blocks (PRBs) for the LP-WUS bandwidth is allocated at the lower edge PRBs of a carrier bandwidth of a cell or the upper edge PRBs of the carrier bandwidth of the cell. In some embodiments, the bandwidth configuration for LP-WUS to the UE is performed during an initial access through a radio resource control (RRC) configuration, or through a system information block x (SIBx). In some embodiments, the method of bandwidth configuration for low power wake up signal (LP-WUS) to the UE further comprises receiving, by the UE, a dedicated downlink BWP for LP-WUS and LP-SS with a maximum bandwidth not greater than a required bandwidth of the LP-WUS. In some embodiments, the dedicated downlink BWP for LP-WUS is configured to match LP-WUR UE bandwidth requirements. In some embodiments, the dedicated downlink BWP for LP-WUS is configured in DownlinkConfigCommonSIB during an initial access. These embodiments provide a bandwidth configuration for LP-WUS, which can enhance the LP-WUR power saving. Further, these embodiments can avoid the unnecessary LP-WUS decoding and reduce the complexity of LP-WUR, avoid the LP-WUR RF retuning for LP-WUR synchronization with the network, and/or support the UEs mobility in the LP-WUS mode.

In some embodiments, a method of radio resource management (RRM) measurement performed by LP-WUR of UE comprises: being configured of, a radio resource management (RRM) measurement. In some embodiments, the method of RRM measurement performed by the LP-WUR of UE further comprises relaxation for the LP-WUR based RRM, wherein the RRM relaxation comprises an RRM measurement only, when a change occurs in the minimum and maximum threshold values of RRM measurement, a report is sent to the network via the MR of the UE. In some embodiments, the method of RRM measurement performed by the LP-WUR of UE further comprises an RRM measurement based on the group of UEs, wherein a single UE in a group of UEs performs RRM measurement during a first RRM cycle/period, and another single UE in a group of UEs performs RRM measurement in a second RRM cycle, wherein the single UE RRM measurement in a RRM cycle is considered for UEs of the group. In some embodiments, the method of RRM measurement performed by the LP-WUR of UE further comprises an RRM measurement based on the LP-WUS. These embodiments provide the LP-WUR based RRM measurement relaxation, which can enhance the LP-WUR power saving. Further, these embodiments can avoid the unnecessary LP-WUS decoding and reduce the complexity of LP-WUR, avoid the LP-WUR RF retuning for LP-WUR synchronization with the network, and/or support the UEs mobility in the LP-WUS mode.

According to the objectives of the SID [1], that is, primarily target low-power WUS/WUR for power-sensitive, small form-factor devices including IoT use cases (such as industrial sensors, controllers) and wearables, the LP-WUS shall be designed with low power consumption as a primary feature, and simplified detection procedure at the LP-WUR side to support a low complex architecture of the LP-WUR. In order to achieve this objective, this disclosure discusses and proposes several methods to reduce the LP-WUR power consumption for low power wake up signals (LP-WUS) detection and decoding. Embodiment 1 explains the LP-WUR monitoring procedure for LP-WUS detection. Embodiment 2 focus on the bandwidth configuration and a dedicated BWP for the LP-WUS transmission to the LP-WUR of UE. Embodiment 3 discuss the RRM relaxation for the LP-WUR based RRM measurement on the top of the existing specification RRM relaxation.

### Embodiment 1: LP-WUS/LP-WUR Monitoring Procedure

LP-WUR monitoring behavior for LP-WUS detection greatly impact the power consumption of LP-WUR as explained in the above sections. To optimize the LP-WUR monitoring behavior for LP-WUS detection/decoding, this embodiment of the present disclosure proposes several solutions based on the conventional monitoring behavior of UEs (e.g., continuous monitoring or duty cycle based) for DL data/signaling, in order to reduce the power consumption of LP-WUR.

### Continuous Monitoring Behavior of LP-WUR:

Continuous monitoring behavior of LP-WUR consume power to detect the LP-WUS. This power consumption increases in the following two cases. 1. Unnecessary decoding of each LP-WUS to identify whether the LP-WUS is transmitted for that specific UE. 2. Continuous monitoring for the detection of LP-WUS, even if the LP-WUS is not transmitted by the network.

In order to reduce the LP-WUR power consumption for LP-WUS detection and avoid the unnecessary decoding of each LP-WUS, this embodiment of the present disclosure propose to enable the LP-WUR monitoring for LP-WUS detection only for a time duration when the UE is triggered by the network to wake up and disable the continuous monitoring behavior of LP-WUR for LP-WUS detection for a time duration from a first trigger until the UE is again trigger by the network to wake up.

The methods of enabling and disabling of continuous monitoring behavior of LP-WUR for LP-WUS detection are explained below.

### Enabling and Disabling of LP-WUR Continuous Monitoring Behavior Via Bitmap in the LP-SS:

This embodiment of the present disclosure proposes that the continuous monitoring behavior of LP-WUS can be enabled/activated and disabled/de-activated via a bitmap in the payload of LP-SS. Since a periodic LP-SS may be required for the LP-WUR of a UE or group of UEs to perform time/frequency synchronization with the network as discussed in 3GPP RAN1 #111 meeting, therefore LP-SS can be used to carry an extra payload to perform enabling and disabling of the LP-WUR monitoring for LP-WUS detection as shown in FIG. 6.

The information carries by the LP-SS for enabling/disabling of the LP-WUR monitoring for LP-WUS detection can be in the form of bitmap, where each bit in this part is assigned to a UE or a group of UEs according to the UE ID or UEs group ID in ascending order when the UEs enter into the LP-WUS mode. The length of payload can be defined as X bits, where X is the total number of bits for enabling/disabling function and it can be in the range of {2, 4, 8} bits. In case the number of information carries in the payload is less than the total bit length of the payload, the remaining unused bits can be considered as reserved bits. For instance, the length of payload is 8 bits, and there are 4 UEs enters into the LP-WUS mode, the bits position or bit index assigned to each UE based on the UE ID or UE ID index, and the total bits in the payload can be arranged as shown in table 1.

TABLE 1
Bits assigned to UEs in the payload of LP-SS

| | Assigned |
|---|---|
| Bit Position in the payload of LP-SS | UE/Reserved |
| 1^{st} bit | UE ID 0 |
| 2^{nd} bit | UE ID 1 |
| 3^{rd} bit | UE ID 2 |
| 4^{th} bit | UE ID 3 |
| 5^{th} bit | Reserved |
| 6^{th} bit | Reserved |
| 7^{th} bit | Reserved |
| 8^{th} bit | Reserved |

Furthermore, when the bit value is 1, it can enable the LP-WUR monitoring for the incoming LP-WUS detection and when the bit value is 0, it can disable or de-activate the continuous monitoring of the LP-WUR for LP-WUS detection. For instance, let's consider fours UEs in the LP-WUS mode, where the LP-WUR monitoring of the first three UEs need to be activated and the last UE needs to be de-activated. The information transmitted in the payload of LP-SS to enabled/disabled the LP-WUR monitoring of UEs are given in table 2.

TABLE 2
Enabling/Disabling of LP-WUR monitoring of UEs

| Bit value | Assigned UE | Activation/De-activation of LP-WUR |
|---|---|---|
| 1 | UE0 | Enabled |
| 1 | UE1 | Enabled |
| 1 | UE2 | Enabled |
| 0 | UE3 | Disabled |

In addition, the enabling and disabling of the LP-WUR monitoring behavior of UEs can also be performed based on the UEs groups. For instance, the LP-WUS mode UEs are distributed into 4 groups, where the LP-WUR monitoring of UEs in the first three groups need be enabled and LP-WUR monitoring of UEs in the 4th group need to be disabled. The bitmap of a payload in LP-SS can carry the information where one bit is assigned to each group to enable/disable the LP-WUR monitoring of UE's groups for LP-WUS detection as shown in table 3.

TABLE 3
Enabling/Disabling of LP-WUR monitoring
for LP-WUS detection of UEs groups

| | Assigned UEs | Activation/De-activation |
|---|---|---|
| Bit value | group | of LP-WUR |
| 1 | UEs group 0 | Enabled |
| 1 | UEs group 1 | Enabled |
| 1 | UEs group 2 | Enabled |
| 0 | UEs group 3 | Disabled |

### Power Saving Benefits of LP-WUR Monitoring Enabling/Disabling:

As mentioned in the above sections that the information for Enabling/Disabling of the LP-WUR monitoring behavior can be carried by the periodic LP-SS. Thus, the LP-WUR of a UE or a group of UEs can periodically decode the LP-SS to enable/disable the continuous monitoring of the LP-WUR for LP-WUS detection. As a result, the LP-WUR only monitors the LP-SS periodically and detect the LP-WUS in a specific configured occasion when the monitoring is activated by the network through the LP-SS. This behavior can avoid the LP-WUR continues monitoring for LP-WUS detection, and unnecessary decoding of each LP-WUS as shown in FIG. 7. Consequently, the enabling/disabling of the LP-WUR continuous monitoring behavior for LP-WUS detection will enhance the LP-WUR power saving for LP-WUS detection and decoding.

### Enabling and Disabling of LP-WUR Continuous Monitoring Behavior Based on the ON/OFF Status of the Main Radio:

For enabling and disabling of the LP-WUR continuous monitoring for LP-WUS detection, an alternative method can be used based on the MR ON/OFF status of the UE. In this embodiment, when the MR of a UE is ON the LP-WUR monitoring of that UE for LP-WUS detection is considered to be de-activated until the MR of the UE is ON. In addition, when the MR of a UE is OFF the LP-WUR monitoring of that UE for LP-WUS detection is considered to be activated. For instance, the LP-WUR trigger the MR to wake up, since the MR is wakened up, the UE can use the ON status of MR to disable the LP-WUR monitoring of UE for LP-WUS detection until the MR is ON as shown in FIG. 8.

Advantage: This method does not require any extra signaling or extra payload from the gNB to enable/disable the LP-WUR monitoring for LP-WUS detection.

### Disabling Event of LP-WUR/WUS Monitoring:

This embodiment of the present disclosure proposes a method through which the gNB can know that the LP-WUS has been successfully detected and decoded by the LP-WUR and perform the disabling of the LP-WUR monitoring for LP-WUS detection. For this purpose, an indication can be used where a gNB receives an indication from the MR of UE that the LP-WUS has successfully received and decoded by the LP-WUR of the UE. This indication can be based on the ACK message (such as HARQ-ACK) from the MR of a UE. In this way, the gNB can disable the LP-WUR monitoring of a UE and stop the repetition of LP-WUS for a specific UE.

The indication of UE to the gNB that the LP-WUS has been successfully decoded can be performed implicitly or explicitly as explained below.

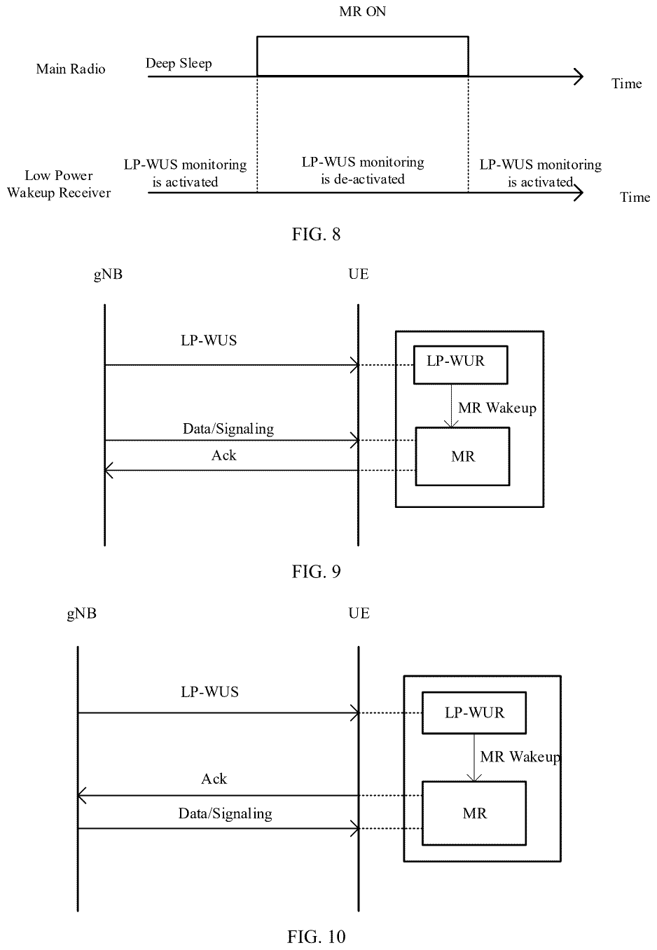

Implicit Indication: In implicit indication the gNB can implicitly derive from the first ACK message received from the MR of UE after receiving data/signaling. In this method, the gNB can transmit data/signaling to the UE after the LP-WUS transmission. When the gNB receive the ACK message for the signaling, it can implicitly derive from the first ACK message which is sent by the MR of UE that the LP-WUS is received by the UE as shown in FIG. 9. In this way the gNB can stop the LP-WUS repetition for that specific UE and disable the LP-WUR monitoring of that UE for LP-WUS detection.

The advantage of implicit indication is that it can reduce the false rate of ACK message to the gNB. For instance, if the LP-WUR of a UE decode a noise signal as LP-WUS and triggered the MR to wake up, the gNB will not receive any false ACK message that the UE has triggered. However, in this case the physical resources (time/frequency resources) will be wasted in case the gNB transmit the data/signaling after LP-WUS without knowing that the MR on/off status.

Explicit Indication: For explicit indication, when the LP-WUS trigger the MR to wake up, the MR can send an ACK message to the gNB and let the gNB know that the LP-WUS has successfully received. After receiving the first ACK message from UE the gNB can send data/signaling to the UE as shown in FIG. 10. However, for this purpose and new ACK message maybe required. The explicit indication of LP-WUS reception may enhance the resource utilization, however it may increase the rate of false ACK message to the gNB in case the LP-WUR of a UE decode a noise and consider it as an LP-WUS.

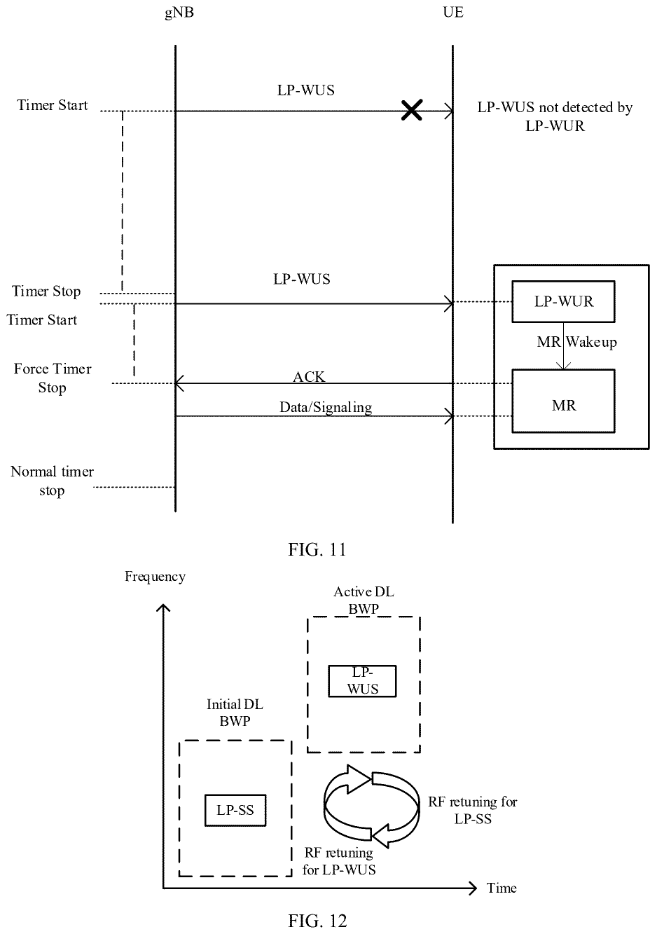

Furthermore, in explicit indication of LP-WUR detection by UE to the gNB, a timer based solution can used, where a timer at gNB side will start when the gNB transmit the LP-WUS to the UE. In case the UE is unable to detect/decode the LP-WUS and the gNB does not receive any ACK message from the MR of that UE until the timer is expired, it can re-transmit the LP-WUS for that specific UE or group of UEs as shown in FIG. 11. In this solution, when the gNB receive the ACK message from the MR of UE, the gNB know that the LP-WUS is received, and it can interrupt the time to stop as shown in FIG. 11. This timer based solution, may help to increase the reliability of the LP-WUS procedure.

### Duty Cycle Monitoring Behavior of LP-WUR for LP-WUS:

In this embodiment of the present disclosure, the duty cycle of LP-WUR monitoring for LP-WUS detection can be derived from the existing DRX and eDRx configuration of the current specification. For instance, if the DRX on duration time configured to the UE is 1280 ms, the duty cycle based monitoring of the LP-WUR for LP-WUS detection can be ON for 1280 ms. In addition, the periodicity of LP-SS and LP-WUS can be defined according to the configured DRx cycle to UE, in order to avoid the mismatch between the LP-SS or LP-WUS occasion and the DRx on time of the duty cycle based monitoring of LP-WUR for LP-WUS detection.

### Embodiment 2: Bandwidth of LP-WUS

This embodiment of the present disclosure discusses how to reduce the LP-WUR power consumption by configuration of frequency resources in one of the active DL BWP or a dedicated BWP for LP-WUS. According to the primary requirements of LP-WUR/LP-WUS the architecture of LP-WUR is much simpler than the Main Radio, due to which the LP-WUR cannot decode the existing CD-SSB to synchronize with the network, and a new synchronization signal such as LP-SS may be used for synchronization of the LP-WUR. The transmission of LP-SS and LP-WUS depends on the gNB scheduling implementation. In some cases, the LP-SS and the LP-WUS can transmitted in different active DL BWP, e.g., the LP-SS is transmitted in the initial DL BWP and the LP-WUS is transmitted in any other active DL BWP as shown in FIG. 12. In this case, the LP-WUR needs to perform frequent RF retuning to receive the LP-SS for synchronization, as illustrated in FIG. 12. This behavior will increase the LP-WUR power consumption and elongate the synchronization process due to the BWP switching delay.

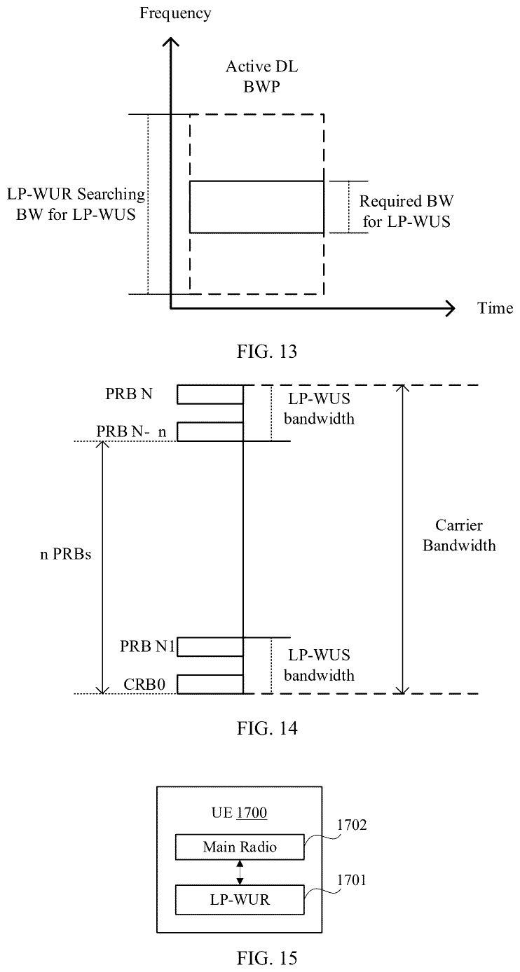

In addition, the assigning of physical resource block (PRB) resources to the LP-WUS is up to the gNB scheduling implementation. In other words, the gNB may assign any PRBs to the LP-WUS in the active DL BWP without the knowledge of the LP-WUR receiving bandwidth. Since the LP-WUS cannot occupy the whole active DL BWP and the assigned PRB of LP-WUS are not know to the LP-WUR of a UE, due to which the LP-WUR has to search the whole BWP for LP-WUS decoding as shown in FIG. 13. In this case, the LP-WUS decoding performance will decline and the LP-WUR will consume more power to find the exact frequency location of the LP-WUS.

In order to solve the above two issues which occurs due to LP-SS transmission in different DL BWP with LP-WUS, and the low bandwidth requirements of LP-WUS, this disclosure proposes the following two solutions.

### Solution1:

The gNB can configure the bandwidth for LP-WUS in terms of physical resource blocks (PRB) to the UE with a defined frequency location. The configured PRB for the LP-WUS bandwidth can be allocated at the lower edge PRBs of the carrier bandwidth of a cell or the upper edge PRBs of the carrier bandwidth of a cell as shown in FIG. 14. Using the edge PRBs to configure the bandwidth of LP-WUS to the UE can minimize the resource wasting and avoid the holes in between the carrier bandwidth for legacy NR channel. In addition, when the LP-WUS is not transmitted, the allocated PRBs of LP-WUS can also be used for other legacy NR channel or signals. However, when LP-WUS is transmitted to the UE then priority shall be given to the LP-WUS transmission in the configured PRBs for LP-WUS. In addition, the LP-WUS shall not be transmitted outside the configured PRBs for the LP-WUS to reduce the power consumption of the LP-WUR for LP-WUS detection. The bandwidth configuration for LP-WUS to the UE can be performed during the initial access through RRC configuration, or through SIBx.

### Solution 2:

Another possible solution is to configure a dedicated downlink BWP for LP-WUS and LP-SS with the maximum bandwidth not greater than the required bandwidth of the LP-WUS. Since the separate downlink BWP contains the LP-SS to synchronize the LP-WUR with the network and LP-WUS to trigger the MR to receive data/signaling, therefore the LP-WUR has not required to perform RF retuning for LP-SS. In addition, the LP-WUR has to search a very specific bandwidth for LP-WUS detection. Thus, the LP-WUR power consumption will be reduced. The dedicated downlink BWP for LP-WUS can be configured to match the LP-WUR UE bandwidth requirements, e.g., not larger than X MHz (where X can be in the range of 5 MHz to 20 MHz). The separate DL BWP can be configured in the DownlinkConfigCommonSIB during the initial access as given in the following IE.

IE:

| | |
|---|---|
| DownlinkConfigCommonSIB ::= | SEQUENCE { |

| | |
|---|---|
| frequencyInfoDL | FrequencyInfoDL-SIB, |
| initialDownlinkBWP | BWP-DownlinkCommon, |
| bcch-Config | BCCH-Config, |
| pcch-Config | PCCH-Config, |

```
    ...,
    [[
```

| | | |
|---|---|---|
| pei-Config-r17 | PEI-Config-r17 | OPTIONAL, -- Need R |

| | | |
|---|---|---|
| initialDownlinkBWP-RedCap-r17 | BWP-DownlinkCommon | OPTIONAL |

-- Need R

| | | |
|---|---|---|
| DownlinkBWP-LPWUS | BWP-DownlinkCommon | OPTIONAL |

```
-- Need R
    ]]
  }
DownlinkBWP-LPWUS: The dedicated (UE-specific/ UEs group specific) configuration for a
separate Downlink BWP for LP-WUS, where the maximum Bandwidth of the BWP is not
greater than the LP-WUS bandwidth requirements.
```

### Embodiment 3: RRM Relaxation

RRM (Radio resource management) measurement including serving cell measurement and neighbor cell measurement is used to support mobility. According to the current specification, serving cell measurement is required to be performed at least once each DRX cycle. Since in Rel-18 UE receiver architecture the MR of a UE is in ultra-deep sleep until it is triggered by the network through LP-WUS. Thus, if the MR is required to wake up each DRX cycle for RRM measurement, it may prevent the MR from going to ultra-deep sleep and abandoned the power saving benefits of the LP-WUS/LP-WUR. Therefore, some RRM function needs to be uploaded to the LP-WUR in order to maintain the ultra-deep sleep of the MR and support RRM measurements and mobility by using LP-WUR of a UE as discussed in 3GPP RAN1 #111 meeting. However, due to the simple architecture of LP-WUR, the LP-WUR may not support the decoding of the existing reference signals to perform RRM measurement, therefore a new reference signal such as LP-SS as discussed above can be used by the LP-WUR for the RRM measurement. However, more RRM relaxation on the top of the existing relaxed RRM measurement [as discussed in TR 38.380] is necessary to consider in order to keep low power consumption feature of the LP-WUR.

This embodiment of the present disclosure discusses several rules of RRM measurement relaxation as given below.

### (1) Only Measurement:

For mobility support i.e., handover, cell selection, reselection two major activities of RRM are performed e.g., measurement and reporting. Since the LP-WUR architecture only support the reception (in order to keep the architecture simple), therefore it is proposed to limit the RRM activities of LP-WUR to RRM measurement only. However, when the reporting is required in case a change occurs in the threshold of RSRP/RSRQ values, the LP-WUR can tiger the MR to perform RRM reporting to the gNB/network. In order to further reduce the RRM reporting to gNB/network, a range of RSRP/RSRQ with a maximum threshold and a minimum threshold value can be defined i.e. [X1 . . . . Xn], where X1 is the minimum threshold and Xn is the maximum threshold. When the values of RSRP/RSRQ is beyond the range of threshold i.e., minimum than the minimum threshold value or maximum than the maximum threshold value the UE can perform reporting. In this way, the reporting can be reduced, which reduces the MR wake and increase the overall UE power saving.

### (2) RRM Relaxation Based on the UEs Group:

This solution is more feasible for stationary UEs such as industrial wireless sensors. In this solution, several stationary UEs can be grouped together based in one geographical area, and a relaxed RRM measurement period can be defined to the group of UEs. A single UE in the group can perform RRM measurement in each RRM period, which is considered for all other UEs in the group. For instance, 4 UEs considered in a group with a defined RRM measurement period, where each UE perform RRM measurement once after 3 RRM measurement period as shown in table 4.

TABLE 4
UEs group based RRM measurement

| RRM measurement period | UEs Perform RRM Measurement | | | |
|---|---|---|---|---|
| Index | UE1 | UE2 | UE3 | UE4 |
| RRM measurement | V | x | x | x |
| Period # 1 | | | | |
| RRM measurement | x | V | x | x |
| Period # 2 | | | | |
| RRM measurement | x | x | V | x |
| Period # 3 | | | | |
| RRM measurement | x | x | x | V |
| Period #4 | | | | |

In this way, the RRM measurement of each UE can be relaxed in time domain e.g., RRM measurement after 3 RRM measurement period in this case. The UEs group based RRM can be more relaxed when the number of UEs increase in the RRM measurement group.

### (3) RRM Measurement Based on the LP-WUS:

Since the LP-WUS for a UE can be configured in a specific time duration when it is required. Therefore, RRM measurement based on the LP-WUS itself can further relax the RRM measurement of the LP-WUR.

FIG. 15 is a block diagram of a UE for wireless communication according to an embodiment of the present disclosure. The UE 1700 includes an LP-WUR 1701 and a Main Radio 1702. The UE 1700 is configured to enable a continuous monitoring behavior of low power wake up receiver (LP-WUR) for low power wake up signal (LP-WUS) detection for a time duration when the UE 1700 is triggered by a network to wake up. The UE 1700 is configured to disable the continuous monitoring behavior of LP-WUR for LP-WUS detection until the UE 1700 is again trigger by the network to wake up. Further, the UE 1700 is configured to perform the method in the above some embodiments.

In summary, his disclosure discusses and proposes several methods to reduce the LP-WUR power consumption for low power wake up signals (LP-WUS) detection and decoding. Some embodiments explain the LP-WUR monitoring procedure for LP-WUS detection. Some embodiments focus on the bandwidth configuration and a dedicated BWP for the LP-WUS transmission to the LP-WUR of UE. Some embodiments discuss the RRM relaxation for the LP-WUR based RRM measurement on the top of the existing specification RRM relaxation. This disclosure discussed several methods of LP-WUR power consumption reduction and have the following advantages: 1. Enhance the LP-WUR power saving. 2. Avoid the unnecessary LP-WUS decoding and reduce the complexity of LP-WUR. 3. Avoid the LP-WUR RF retuning for LP-WUR synchronization with the network. 4. Support the UEs mobility in the LP-WUS mode.

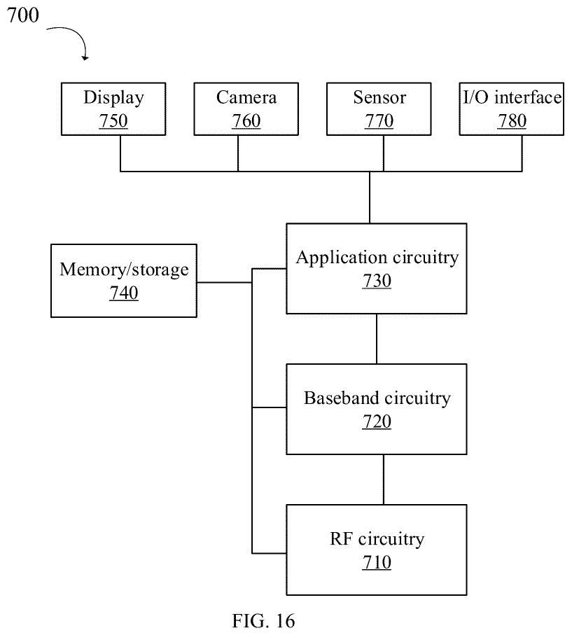

FIG. 16 is a block diagram of an example system 700 for wireless communication according to an embodiment of the present disclosure. Embodiments described herein may be implemented into the system using any suitably configured hardware and/or software. FIG. 16 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of low power wake up receiver (LP-WUR) monitoring procedure for low power wake up signal (LP-WUS) detection, comprising:
enabling a monitoring behavior of LP-WUR for LP-WUS detection, wherein a user equipment (UE) is configured to enable the monitoring behavior of LP-WUR for LP-WUS detection for a time duration when the UE is triggered by a network/gNB to wake up, and the UE is configured to disable the monitoring behavior of LP-WUR for LP-WUS detection for a time duration from a first trigger until the UE is again trigger by the network/gNB to wake up.

2-8. (canceled)

9. The method of LP-WUR monitoring procedure for LP-WUS detection according to claim 1, wherein enabling and disabling the monitoring behavior of LP-WUR for LP-WUS detection is based on on/off status of a main radio (MR) of the UE;
wherein when the MR of the UE is on, the monitoring behavior of LP-WUR of the UE for LP-WUS detection is considered to be de-activated until the MR of the UE is off,
wherein when the MR of the UE is off, the monitoring behavior of LP-WUR of the UE for LP-WUS detection is considered to be activated.

10-11. (canceled)

12. The method of LP-WUR monitoring procedure for LP-WUS detection according to claim 1, wherein enabling and disabling the monitoring behavior of LP-WUR for LP-WUS detection comprises transmitting, by the MR of the UE, an indication to the network/gNB that the LP-WUS has successfully received and decoded by the LP-WUR of the UE.

13. The method of LP-WUR monitoring procedure for LP-WUS detection according to claim 12, wherein the indication is used for the network/gNB to derive from a first ACK message from the MR of the UE after receiving data/signaling.

14. The method of LP-WUR monitoring procedure for LP-WUS detection according to claim 12, wherein the indication is used when the LP-WUS triggers the MR to wake up, the MR sends an ACK message to the network/gNB and let the network/gNB knows that the LP-WUS has successfully received.

15. The method of LP-WUR monitoring procedure for LP-WUS detection according to claim 14, wherein when the UE is unable to detect/decode the LP-WUS and the network/gNB does not receive any ACK message from the MR of the UE until a timer is expired, the LP-WUS is re-transmit for the UE or the group of UEs.

16. The method of LP-WUR monitoring procedure for LP-WUS detection according to claim 1, wherein a duty cycle of the monitoring behavior of LP-WUR for LP-WUS detection is derived from a DRX configuration and/or eDRx configuration.

17. A method of a bandwidth configuration for low power wake up signal (LP-WUS) to a user equipment (UE), comprising a bandwidth configuration for LP-WUS with a defined frequency location.

18. The method of bandwidth configuration for LP-WUS to the UE according to claim 17, wherein the configured bandwidth in terms of physical resource blocks (PRBs) for the LP-WUS bandwidth is allocated at the lower edge PRBs of a carrier bandwidth of a cell or the upper edge PRBs of the carrier bandwidth of the cell.

19. The method of bandwidth configuration for LP-WUS to the UE according to claim 17, wherein the bandwidth configuration for LP-WUS to the UE is performed during an initial access through a radio resource control (RRC) configuration, or through a system information block x (SIBx).

20-22. (canceled)

23. A method of radio resource management (RRM) measurement performed by a low power wake up receiver (LP-WUR) of a user equipment (UE), comprising: being configured of, a radio resource management (RRM) measurement.

24. The method of RRM measurement performed by the LP-WUR of the UE according to claim 23, further comprising relaxation for the LP-WUR based RRM, wherein the RRM relaxation comprises an RRM measurement only, when a change occurs in the minimum and maximum threshold values of RRM measurement, a report is sent to the network/gNB via the MR of the UE.

25. The method of RRM measurement performed by the LP-WUR of the UE according to claim 23, further comprising an RRM measurement based on the group of UEs, wherein a single UE in a group of UEs performs RRM measurement during a first RRM cycle/period, and another single UE in a group of UEs performs RRM measurement in a second RRM cycle, wherein the single UE RRM measurement in a RRM cycle is considered for UEs of the group.

26. The method of RRM measurement performed by the LP-WUR of the UE according to claim 23, further comprising an RRM measurement based on the LP-WUS.

27. (canceled)
